(19) United States
(12) Patent Application Publication
(10) Pub. No.: US 2026/0087335 A1
(43) Pub. Date: Mar. 26, 2026

(54) CASCADED MAX POOLING FILTERS CONFIGURED FOR A HARDWARE ACCELERATION DEVICE

(71) Applicant: STMICROELECTRONICS INTERNATIONAL N.V., Geneva (CH)

(72) Inventor: Alessandro BUSCHINI, Montano Lucino (IT)

(21) Appl. No.: 18/892,067

(22) Filed: Sep. 20, 2024

(51) Int. Cl. G06N 3/063; G06N 3/0464

(52) U.S. Cl. CPC G06N 3/063; G06N 3/0464

(57) ABSTRACT

An example apparatus, computer-implemented method, and a computer program product for generating a cascaded max pooling filter to be executed by a hardware acceleration device are provided. An example apparatus may include a hardware acceleration device, and a controller. The hardware acceleration device configured to perform optimized max pooling operations up to a h max width and max height on an input data map. The controller configured to: receive a target max pooling filter greater than the max height, or the max width of the hardware acceleration device, and determine a cascaded max pooling filter comprising one or more max pooling sub-filters smaller than the max height and the max width of the hardware acceleration device. Wherein sequentially applying the max pooling sub-filters yields an output data map equivalent to an output data map that would result from performing a max pooling operation using the target max pooling filter.

### TECHNOLOGICAL FIELD

Embodiments of the present disclosure relate generally to max pooling operations, and more particularly, to optimizing max pooling operations for increased performance on a hardware acceleration device.

### BACKGROUND

A machine learning model is a computer-implemented algorithm that may learn from data with or without relying on rules-based programming. These models enable reliable, repeatable decisions and results, uncovering hidden insights through machine-based learning from historical relationships and trends in the data. A neural network may be configured to extract various features from an input sample and classify the input sample based on the various features. Max pooling is an operation often performed as part of a neural network to reduce the spatial dimensions of feature maps and provide additional features.

Applicant has identified many technical challenges and difficulties associated with performing max pooling operations. Through applied effort, ingenuity, and innovation, Applicant has solved problems related to performing max pooling operations on accelerated hardware by developing solutions embodied in the present disclosure, which are described in detail below.

### BRIEF SUMMARY

Various embodiments are directed to an example apparatus, computer-implemented method, and a computer program product for generating a cascaded max pooling filter to be executed by a hardware acceleration device. An example apparatus may comprise a hardware acceleration device, and a controller. The hardware acceleration device configured to perform optimized max pooling operations up to a hardware accelerated max pooling filter max width and a hardware accelerated max pooling filter max height on a two-dimensional input data map. The controller electrically connected to the hardware acceleration device and configured to: receive a target max pooling filter comprising a target max pooling filter height and a target max pooling filter width, wherein the target max pooling filter height is greater than the hardware accelerated max pooling filter max height, or the target max pooling filter width is greater than the hardware accelerated max pooling filter max width; and determine a cascaded max pooling filter comprising one or more max pooling sub-filters, each of the one or more max pooling sub-filters comprising a max pooling sub-filter width equal to or smaller than the hardware accelerated max pooling filter max width and a max pooling sub-filter height equal to or smaller than the hardware accelerated max pooling filter max height. Wherein, sequentially applying each of the one or more max pooling sub-filters yields a two-dimensional output data map equivalent to a target output data map that would result from performing a max pooling operation using the target max pooling filter.

In some embodiments, the controller is configured to receive max pooling hyperparameters including at least a max pooling padding parameter or a max pooling stride parameter.

In some embodiments, the controller comprises a compiler.

In some embodiments, the compiler configures the hardware acceleration device to execute the cascaded max pooling filter on the two-dimensional input data map.

In some embodiments, the compiler reconfigures the hardware acceleration device during operation to execute a second cascaded max pooling filter based on a second target max pooling filter.

In some embodiments, the hardware acceleration device represents a computational node in a convolutional neural network.

An example computer-implemented method is further provided. The example computer-implemented method, comprising receiving a hardware accelerated max pooling filter max width and a hardware accelerated max pooling filter max height corresponding to a hardware acceleration device configured to perform optimized max pooling operations up to the hardware accelerated max pooling filter max width and the hardware accelerated max pooling filter max height on a two-dimensional input data map. The example computer-implemented method further comprising receiving a target max pooling filter comprising a target max pooling filter height and a target max pooling filter width, wherein the target max pooling filter height is greater than the hardware accelerated max pooling filter max height, or the target max pooling filter width is greater than the hardware accelerated max pooling filter max width. The example computer-implemented method further comprising determining a cascaded max pooling filter comprising one or more max pooling sub-filters, each of the one or more max pooling sub-filters comprising a max pooling sub-filter width equal to or smaller than the hardware accelerated max pooling filter max width and a max pooling sub-filter height equal to or smaller than the hardware accelerated max pooling filter max height. Wherein sequentially applying each of the one or more max pooling sub-filters yields a two-dimensional output data map equivalent to a target output data map that would result from performing a max pooling operation using the target max pooling filter.

In some embodiments, determining the cascaded max pooling filter further comprises, for each max pooling sub-filter: determining a set of candidate max pooling sub-filter widths comprising each filter width supported by the hardware acceleration device having a valid output filter width; determining a set of candidate max pooling sub-filter heights comprising each filter height supported by the hardware acceleration device having a valid output filter height; and selecting a max pooling sub-filter comprising a max pooling sub-filter width based on a maximum filter width in the set of candidate max pooling sub-filter widths, and a max pooling sub-filter height based on a maximum filter height in the set of candidate max pooling sub-filter heights.

In some embodiments, for each filter width supported by the hardware acceleration device, the output filter width is determined based at least in part on an input filter width and the filter width supported by the hardware acceleration device. Wherein for each filter height supported by the hardware acceleration device, the output filter height is determined based at least in part on an input filter height and the filter height supported by the hardware acceleration device.

In some embodiments, dimensions of a first input filter are based on the target max pooling filter, and dimensions of a subsequent input filter are based on the output filter width and the output filter height from a previous iteration of the cascaded max pooling filter.

In some embodiments, the one or more max pooling sub-filters are selected until a selected max pooling sub-filter width is greater than or equal to the output filter width; and a selected max pooling sub-filter height is greater than or equal to the output filter height.

In some embodiments, the computer-implemented method of claim 8, further comprises receiving max pooling hyperparameters including at least a max pooling padding parameter or a max pooling stride parameter.

In some embodiments, in an instance in which the max pooling padding parameter is greater than one, the output filter width and the output filter height are determined based at least in part on the max pooling padding parameter.

In some embodiments, in an instance in which the max pooling stride parameter is greater than one, the output filter width and the output filter height are determined based at least in part on the max pooling stride parameter.

In some embodiments, the computer-implemented method further comprises configuring the hardware acceleration device to execute the cascaded max pooling filter on the two-dimensional input data map.

A computer program product having computer-readable program code portions stored therein is further provided. In some embodiments, the computer-readable program code portions comprise an executable portion configured to: receive a hardware accelerated max pooling filter max width and a hardware accelerated max pooling filter max height corresponding to a hardware acceleration device configured to perform optimized max pooling operations up to the hardware accelerated max pooling filter max width and the hardware accelerated max pooling filter max height on a two-dimensional input data map; receive a target max pooling filter comprising a target max pooling filter height and a target max pooling filter width, wherein the target max pooling filter height is greater than the hardware accelerated max pooling filter max height, or the target max pooling filter width is greater than the hardware accelerated max pooling filter max width; and determine a cascaded max pooling filter comprising one or more max pooling sub-filters. In some embodiments, each of the one or more max pooling sub-filters comprises: a max pooling sub-filter width equal to or smaller than the hardware accelerated max pooling filter max width; and a max pooling sub-filter height equal to or smaller than the hardware accelerated max pooling filter max height. Wherein sequentially applying each of the one or more max pooling sub-filters yields a two-dimensional output data map equivalent to a target output data map that would result from performing a max pooling operation using the target max pooling filter.

In some embodiments, the computer-readable program code portions comprising the executable portion are further configured to configure the hardware acceleration device to execute the cascaded max pooling filter on the two-dimensional input data map.

In some embodiments, to determine the cascaded max pooling filter, the computer-readable program code portions comprising the executable portion are further configured to, for each max pooling sub-filter: determine a set of candidate max pooling sub-filter widths comprising each filter width supported by the hardware acceleration device having a valid output filter width; determine a set of candidate max pooling sub-filter heights comprising each filter height supported by the hardware acceleration device having a valid output filter height; and select a max pooling sub-filter comprising a max pooling sub-filter width based on a maximum filter width in the set of candidate max pooling sub-filter widths, and a max pooling sub-filter height based on a maximum filter height in the set of candidate max pooling sub-filter heights.

In some embodiments, for each filter width supported by the hardware acceleration device, the output filter width is determined based at least in part on an input filter width and the filter width supported by the hardware acceleration device; wherein for each filter height supported by the hardware acceleration device, the output filter height is determined based at least in part on an input filter height and the filter height supported by the hardware acceleration device.

In some embodiments, subsequent output filter dimensions are determined based on the output filter from a previous iteration and the max pooling sub-filter.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example convolutional neural network in accordance with an example embodiment of the present disclosure.

FIG. 2A-FIG. 2B illustrate an example max pooling operation in accordance with an example embodiment of the present disclosure.

FIG. 3 depicts an example block diagram of a max pooling node in accordance with an example embodiment of the present disclosure.

FIG. 4 illustrates an example max pooling operation based on a 6×6 filter in accordance with an example embodiment of the present disclosure.

FIG. 5 illustrates an example cascaded max pooling filter in accordance with an example embodiment of the present disclosure.

FIG. 6 depicts an example process for determining a cascaded max pooling filter for a hardware acceleration device in accordance with an example embodiment of the present disclosure.

FIG. 7 illustrates an example flowchart depicting an example process for determining a cascaded max pooling filter for a hardware acceleration device in accordance with an example embodiment of the present disclosure.

FIG. 8 illustrates example input max pooling filters and output filters in a cascaded max pooling filter in accordance with an example embodiment of the present disclosure.

FIG. 9 illustrates an example block diagram depicting components of an example controller in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with efficiently performing max pooling operations on a hardware acceleration device. As understood by those of skill in the field to which the present disclosure pertains, there are numerous benefits to increasing the speed and efficiency with which max pooling operations are performed on input data maps.

Machine learning and artificial intelligence (ML/AI) are methods used to devise complex models and algorithms that operate on data in order to generate predictions. A machine learning model is a computer-implemented algorithm that may learn from data with or without relying on rules-based programming. These machine learning models enable reliable, repeatable decisions and results, uncovering hidden insights through machine-based learning from historical relationships and trends in the data. ML/AI methods are used in numerous applications, including computer vision/image processing, speech recognition, natural language processing, and so on.

Deep learning methods are a subset of ML/AI methods based on neural networks. A neural network may be configured to extract various features from an input sample and classify the input sample based on the various features. Neural networks, such as convolutional neural networks, are commonly used in image processing applications to extract features from an input image and make decisions based on the extracted features and known classifications.

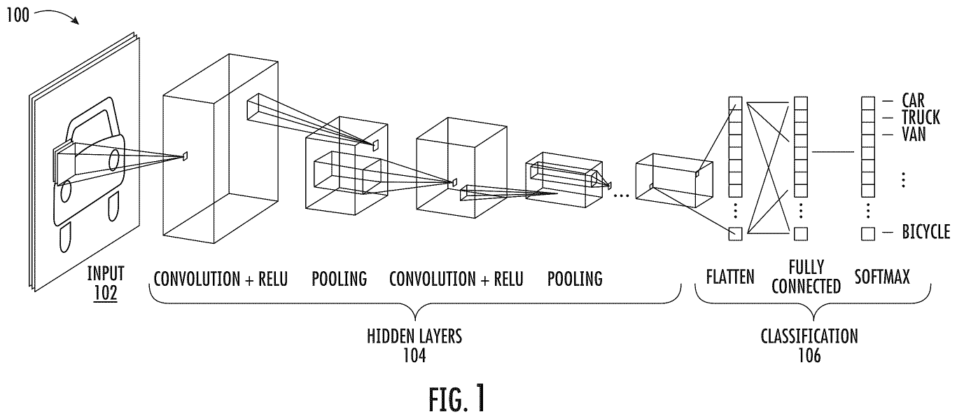

Referring now to FIG. 1, an example convolutional neural network 100 is provided. As depicted in FIG. 1, the example convolutional neural network 100 includes hidden layers 104 and classification models 106 for generating predictions. The hidden layers 104 are configured to receive an input data map 102 (e.g., image) and perform various operations to generate a set of features based on the input data map. The classification models 106 generate a prediction based on the set of features produced by the hidden layers 104.

As depicted in FIG. 1, the example convolutional neural network 100 comprises a plurality of hidden layers 104 configured to extract features from the input data map 102. The hidden layers 104 (e.g., computational nodes) may comprise a plurality of convolution layers (including rectified linear units) and pooling layers. In general, convolutional neural networks (CNNs) utilize learnable filters (e.g., kernels) that are adjusted during a training process to extract features from the input data map 102, such as images, to generate a classification. Operations performed at a convolutional layer may include sliding the learnable filter over the input data map 102 to compute a value at each location and produce an output feature map.

In addition to convolution layers, the hidden layers 104 further include pooling layers. Pooling layers are often applied to the resulting convolutional layer data. Pooling layers may be utilized in a convolutional neural network 100 to reduce the spatial dimensions of the output feature maps generated by the convolutional layers. In addition, pooling layers may provide at least a small amount of translation invariance, meaning tolerance for objects that have moved with regard to training objects.

Max pooling is a common operation performed in the hidden layers 104 of a convolutional neural network 100. During a max pooling operation, a max pooling filter is applied to various locations of the input data map 102. The max pooling operation determines the maximum value for the batch of values of the input data map 102 within the max pooling filter. The max pooling operation outputs a single max value corresponding to the location of the max pooling filter in an output data map.

In some embodiments, the input data map 102 may comprise a two-dimensional array of data. A two-dimensional input data map 102 comprising a two-dimensional array of data may be defined by a x-dimension (e.g., width, or lateral dimension) and a y-dimension (e.g., height, or vertical dimension). Data within the two-dimensional input data map 102 may be referenced by an x-location and y-location.

In an instance in which a two-dimensional input data map 102 is received, a max pooling filter is defined by a max pooling filter width and a max pooling filter height. The max pooling filter width indicates the number of values in the two-dimensional input data map 102 in the x-direction to which the max pooling filter is applied at each iteration. The max pooling filter height indicates the number of values in the two-dimensional input data map 102 in the y-direction to which the max pooling filter is applied at each iteration. A max pooling filter height and max pooling filter width may be adjusted based on the specific application, the type of input data, the operations performed in the hidden layers 104, the desired reduction in spatial dimensions, and so on. As non-limiting examples, a max pooling filter may comprise a 2×2 max pooling filter, 3×3 max pooling filter, 4×4 max pooling filter, 6×6 max pooling filter, 10×10 max pooling filter, 4×6 max pooling filter, 8×10 max pooling filter, 10×12 max pooling filter, and so on.

By determining a max value within a max pooling filter and outputting a single value, the max pooling operation generates an output data map that has been down-sampled (e.g., pooled) compared to the input data map 102. Generating down-sampled output data maps may effectively summarize the features contained in an input data map 102 in a reduced size. Thus, generating a down-sampled output data map may enable various operations in the convolutional neural network 100 to be performed more efficiently. In addition, utilizing max pooling within the hidden layers 104 of the convolutional neural network 100 improves the translation invariance of a ML/AI method utilizing a convolutional neural network 100.

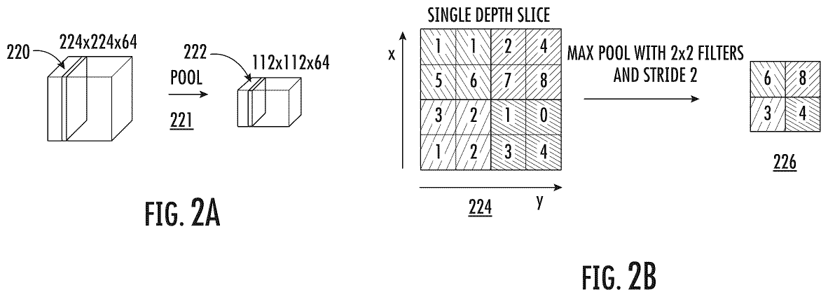

Referring now to FIG. 2A and FIG. 2B, an example max pooling operation is depicted. As depicted in FIG. 2A, an input data map 220 may be extracted from a portion of a data set, for example, a sequence of input data maps. A pooling operation 221 may be applied to the input data map 220 and as depicted in FIG. 2A, may generate a reduced size, or down-sampled output data map 222 based on hyperparameters of the configured pooling operation 221. A pooling operation 221 may be any operation or set of operations configured to operate on an input data map 220 to generate an output data map 222 based on an operation defined by a pooling filter type. In general, pooling operations 221 may include average pooling, minimum pooling, max pooling, global pooling, and so on, although, the present embodiment relates specifically to max pooling as described in relation to FIG. 2B. After a pooling operation 221 is performed, one or more dimensions of the resulting output data map 222 may be reduced compared to the input data map 220. For example, in some embodiments, the input data map may include a 224×224 array of pixel values. Executing a pooling operation 221 comprising a pooling filter with a stride of 2 on the input data map 220 may result in a 112×112 output data map 222 of pixels. The pooling operation 221 may be applied to each input data map 220 in the sequence of input data maps comprising the data set.

A pooling operation 221 may be defined by various hyperparameters, such as a pooling filter type, a pooling filter size, a stride, and padding. A pooling filter type may identify the operation performed on the input data within the pooling filter, e.g., determining the max value within the filter, determining the average value within the filter, and so on. A pooling filter size indicates the number of values in an input data map 220 to which the pooling operation 221 will be applied. For example, a pooling filter size may comprise a 2-dimensional rectangular filter comprising a pooling filter height and a pooling filter width. A stride may indicate the number of positions the pooling filter is moved between successive operations. For example, a stride of two indicates the pooling filter is to be moved two positions in the input data map 220 between each successive operation. In some embodiments, the hyperparameters may specify a multi-dimensional stride. For example, a stride in the x direction and a stride in the y direction. The stride length may determine the amount of down-sampling between the input data map 220 and the output data map 222. In some embodiments, a max pooling padding parameter may be defined. The max pooling padding parameter dictates the amount of padding to apply to each dimension of the input data map 220. Padding may enable more accurate determination of pooling values, especially at the edges of the input data map 220.

Referring now to FIG. 2B, an example max pooling operation on an example input data map 224 is provided. As depicted in the example of FIG. 2B, the pooling filter type is a max pooling operation, the pooling filter size is 2×2, the max pooling stride is two, and there is no padding. At each location of the max pooling operation, the max pooling filter size is used to determine the values in the input data map 224 to which the max pooling operation may be applied. For example, at (x, y) position (0,0) at the top left of the image, the values at (0,0), (1,0), (0,1), and (1,1) are within the max pooling filter. Thus, the max pooling operation determines the max value among the values at each of those locations (1, 1, 5, 6) which is 6. The max value (6) is written to the corresponding location (0,0) of the output data map 226.

The max pooling filter is then moved two positions in the positive x direction because the stride is 2. At the second position (2,0), the values at (2,0), (3,0), (2,1), and (3,1) are within the max pooling filter. Thus, the max pooling operation determines the max value among the values at each of those locations (2, 4, 7, 8) which is 8. The max value (8) is written to the corresponding location (1,0) of the output data map 226.

The max pooling filter is then moved two positions in the positive y direction because the end of the row was reached. At the third position (0,2), the values at (0,2), (1,2), (0,3), and (1,3) are within the max pooling filter. Thus, the max pooling operation determines the max value among the values at each of those locations (3, 2, 1, 2) which is 3. The max value (3) is written to the corresponding location (0,1) of the output data map 226.

The max pooling filter is then moved two positions in the positive x direction because the stride is 2. At the fourth position (2,2), the values at (2,2), (3,2), (2,3), and (3,3) are within the max pooling filter. Thus, the max pooling operation determines the max value among the values at each of those locations (1, 0, 3, 4) which is 4. The max value (4) is written to the corresponding location (1,1) of the output data map 226.

As depicted in FIG. 2B, the output data map 226 of the max pooling operation is reduced in size and each location in the output data map 226 includes the max value of each iteration of the max pooling operation.

A max pooling operation, such as the max pooling operation depicted in FIG. 2B may be performed millions of times every second in a convolutional neural network on large input data maps. Thus, various mechanisms have been devised to increase the speed of the max pooling operation. One such mechanism is to design hardware devices (e.g., a hardware acceleration device) specifically configured to perform max pooling operations. Hardware acceleration devices configured to perform max pooling operations may include registers, comparators, muxes, arithmetic units, and other necessary hardware components specifically configured to rapidly perform max pooling operations on an input data map. However, hardware acceleration devices provide limitations on the hyperparameters for which the hardware acceleration device provides speed and/or efficiency gains. For example, a hardware acceleration device may be configured to accelerate a max pooling operation up to a pre-determined max pooling filter max width (e.g., hardware accelerated max pooling filter max width) and a max pooling filter max height (e.g., hardware accelerated max pooling filter max height).

In an instance in which a target max pooling filter width or height, desired in an application, exceeds the max pooling filter max width and/or max pooling filter max height of the hardware acceleration device, the max pooling operation suffer significant runtime performance reduction. For example, the host processor may be utilized to perform one or more of the operations associated with the max pooling operation. One of the main drawbacks of using the host processor to perform max pooling operations, is the flow of data within and between the hardware acceleration devices is interrupted. The input data map may be stored in memory, fetched, the max pooling filter may be applied, and then the output data map is stored back into memory. The interaction with memory and performance of operations on the host processor results in significant performance reduction. In addition, the activation space allocated by the compiler could increase.

Performing the max pooling operation on the host processor requires multiple memory accesses and software code that is significantly slower than performing the max pooling operation on hardware components. Thus, in an instance in which the desired max pooling operation filter size exceeds the max pooling filter dimensions supported by the hardware acceleration device, the max pooling operation is significantly slowed. Slowing the max pooling operation may adversely affect the performance of a convolutional neural network or other device relying on the max pooling operation.

The various example embodiments described herein utilize various techniques to generate a cascaded max pooling filter comprising a plurality of max pooling sub-filters each of which have a max pooling sub-filter width less than the hardware accelerated max pooling filter max width and a max pooling sub-filter height less than the hardware accelerated max pooling filter max height, and when executed sequentially produce an output data map equivalent to the target output data map resulting from the execution of the target max pooling filter.

For example, a max pooling node in accordance with an example embodiment of the present disclosure includes a controller configured to receive a target max pooling filter and various hyperparameters of the max pooling operation to generate a sequence of sub-filters replicating the operation of the target max pooling filter desired by the application.

In some embodiments, the controller associated with the max pooling node may be configured to dynamically update a configuration of the hardware acceleration device to support the operation of the cascaded max pooling filter, for example, by performing a dynamic reconfigure of one or more portions of the hardware acceleration device.

In addition, in some embodiments, a max pooling node in accordance with an example embodiment of the present disclosure may be configured to receive hyperparameters, such as a max pooling stride parameter and a max pooling padding parameter and generate a cascaded max pooling filter based on the received hyperparameters.

As a result of the herein described example embodiments and in some examples, the speed and efficiency of a hardware acceleration device configured to perform a max pooling operation may be greatly improved. In particularly, in an instance in which a max pooling operation comprising a target max pooling filter with dimensions bigger than the supported dimensions of the hardware acceleration device is executed, the performance of the max pooling operation may be significantly increased. Further, reducing the reliance on software libraries to perform various operations of the max pooling operation may reduce the power consumption and size necessary for a hardware acceleration device configured to support max pooling operations.

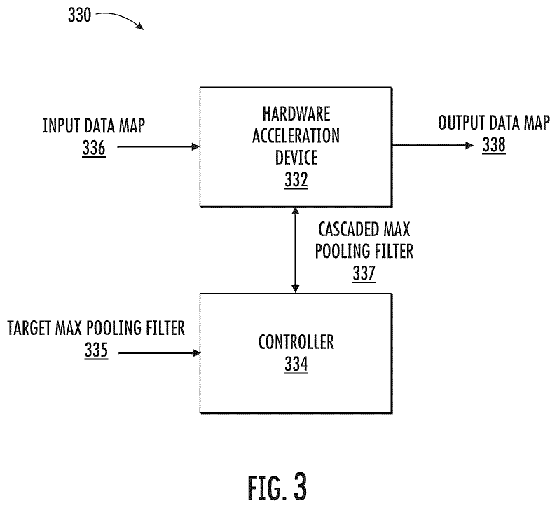

Referring now to FIG. 3, a block diagram of an example max pooling node 330 is provided. A max pooling node 330 may comprise one or more computational nodes in the hidden layers of a convolutional neural network (e.g., convolutional neural network 100 as depicted in FIG. 1). As depicted in FIG. 3, the controller 334 is configured to receive a target max pooling filter 335 and generate a cascaded max pooling filter 337 for a hardware acceleration device 332. The hardware acceleration device 332 is configured to receive an input data map and the cascaded max pooling filter 337 and generate an output data map 338.

As depicted in FIG. 3, the example max pooling node 330 includes a hardware acceleration device 332. A hardware acceleration device 332 comprises circuitry including hardware components configured to perform optimized max pooling operations up to a pre-determined max pooling filter width (e.g., hardware accelerated max pooling filter max width) and height (e.g., a hardware accelerated max pooling filter max height). In an instance in which a dimension of the target max pooling filter 335 exceeds a corresponding dimension of the hardware acceleration device 332, the controller 334 is utilized to perform the max pooling operation. Transfer of data between the hardware acceleration device 332 and the controller 334 may lead to significant slow downs in processing times. Thus, determining a sequence of max pooling filters comprising a cascaded max pooling filters 337 based on the max pooling filter width and height of the hardware acceleration device 332 may enable greater performance than even a single target max pooling filter having one or more dimensions greater than the max pooling filter width and height of the hardware acceleration device 332.

In some embodiments, portions of the hardware configuration of a hardware acceleration device 332 may be configurable by a compiler. For example, a compiler may determine the hardware configuration of the hardware acceleration device 332 and implement the hardware configuration on the hardware acceleration device 332. In some embodiments, the hardware configuration of a hardware acceleration device 332 may occur dynamically, for example, using a dynamic compilation mechanism.

In some embodiments, the hardware acceleration device 332 may include a plurality of hardware acceleration devices. In such an instance, each hardware acceleration device may be configured with one or more stages of the cascaded max pooling filter 337. Thus, the hardware acceleration devices may be interconnected to receive an input data map 336 from the previous hardware acceleration device in the sequence of hardware acceleration devices and output an output data map 338 to the next hardware acceleration device in the sequence of hardware acceleration devices. In an instance in which a single hardware acceleration device 332 is utilized, the hardware acceleration device 332 may be reconfigured between stages of the cascaded max pooling filter 337. In addition, the output data map 338 may be transmitted as the input data map 336 at the input of the hardware acceleration device 332.

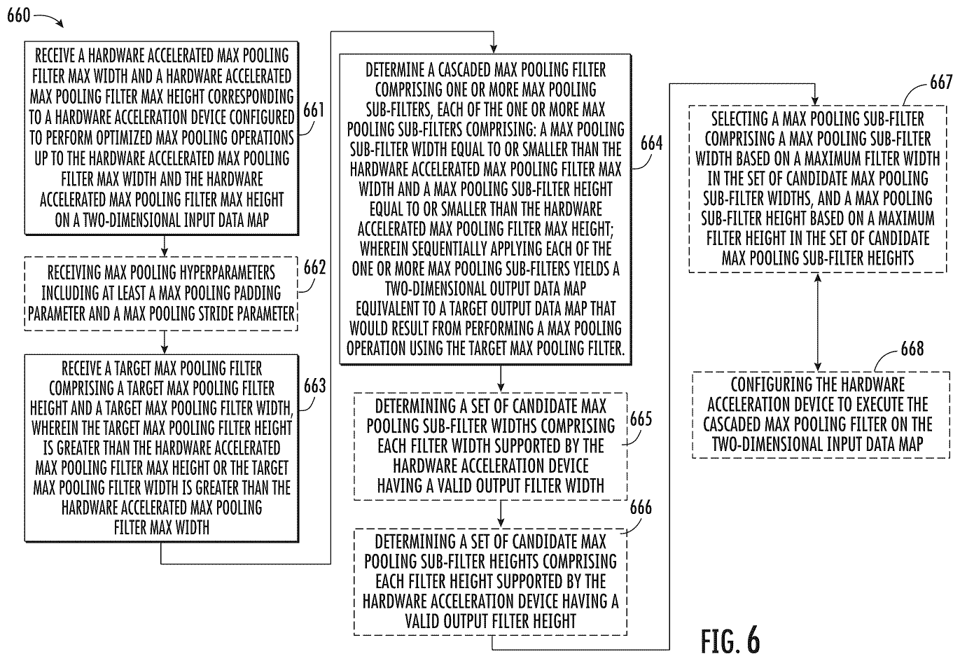

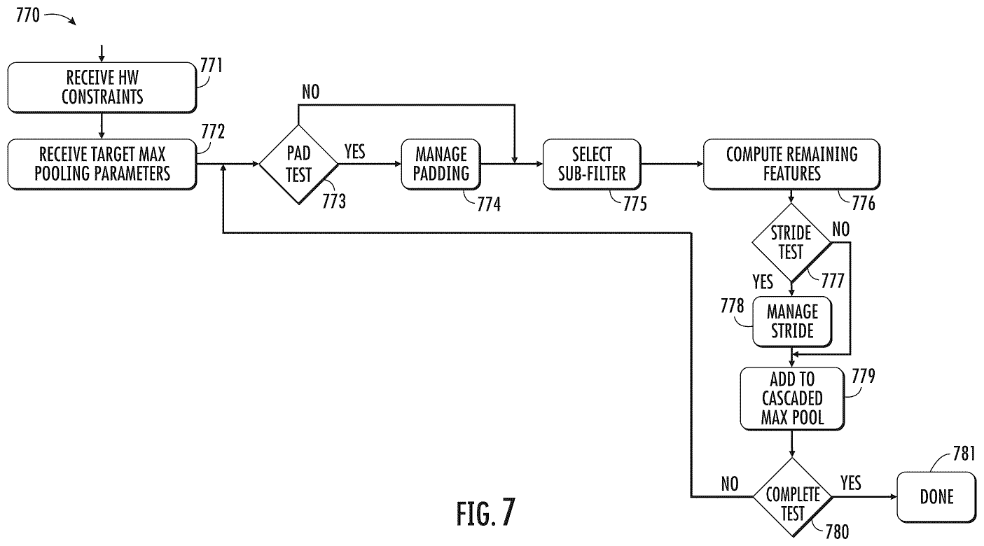

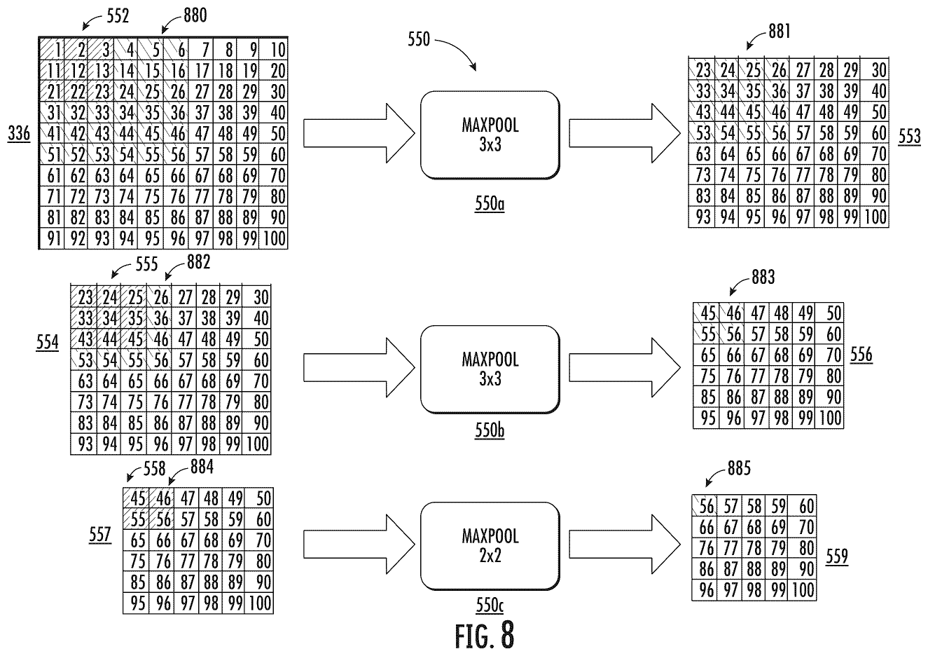

As further depicted in FIG. 3, the max pooling node 330 includes a controller 334. The controller 334 comprises any circuitry, processor, host processor, or other processing device comprising hardware and/or software configured to receive a target max pooling filter 335 and generate a cascaded max pooling filter 337 based on the hardware accelerated max pooling filter max width and hardware accelerated max pooling filter max height of the connected hardware acceleration device 332. In addition, the controller 334 may receive additional hyperparameters associated with the max pooling operation, for example, a max pooling padding parameter and/or a max pooling stride parameter. The max pooling padding parameter indicates the number of padding positions to be added to each side of the input data map 336 during the max pooling operation. The max pooling stride parameter dictates the movement of a max pooling filter (e.g., max pooling sub-filter) between each iteration of the max pooling operation. One or more processes executed by the controller 334 are further described in relation to FIG. 6 and FIG. 7. Various components of the controller 334 are further described in relation to FIG. 8. In some embodiments, the controller 334 may be remote from the max pooling node 330, for example, on a host processor.

As further depicted in FIG. 3, the controller 334 may be configured to receive a target max pooling filter 335. A target max pooling filter 335 is any data construct identifying a window, kernel, mask, etc. on which a max pooling operation is performed. A target max pooling filter 335 includes target max pooling dimensions, for example, a target max pooling width and a target max pooling height. The dimensions of a target max pooling filter 335 may be determined based on the application. For example, the feature sets generated by a max pooling node 330 may vary based on the dimensions of the max pooling filter 335. The dimensions of the max pooling filter 335 may be provided by a user, an application, a machine learning model, or other external program.

As further depicted in FIG. 3, the controller 334 is configured to generate a cascaded max pooling filter 337. A cascaded max pooling filter 337 comprises a plurality of max pooling sub-filters configured to generate an output data map 338 when performed sequentially, which is equivalent to a target output data map resulting from the execution of a target max pooling filter. For example, in one embodiment, a 6×6 max pooling filter 337 may be replicated by executing a 3×3 max pooling sub-filter, followed by a 3×3 max pooling sub-filter, followed by a 2×2 max pooling sub-filter. In an instance in which a dimension of a target max pooling filter 335 exceeds a maximum dimension of the hardware accelerated max pooling filter (e.g., target max pooling filter 335 height exceeds hardware accelerated max pooling filter height or target max pooling filter 335 width exceeds hardware accelerated max pooling filter width) a cascaded max pooling filter 337 comprising a plurality of max pooling sub-filters each having dimensions smaller than the maximum dimension of the hardware accelerated max pooling filter may be generated. In such an instance, the cascaded max pooling filter 337 may be executed faster than the target max pooling filter yielding an equivalent output data map 338. Example processes by which the cascaded max pooling filter 337 are generated are further described in relation to FIG. 6 and FIG. 7.

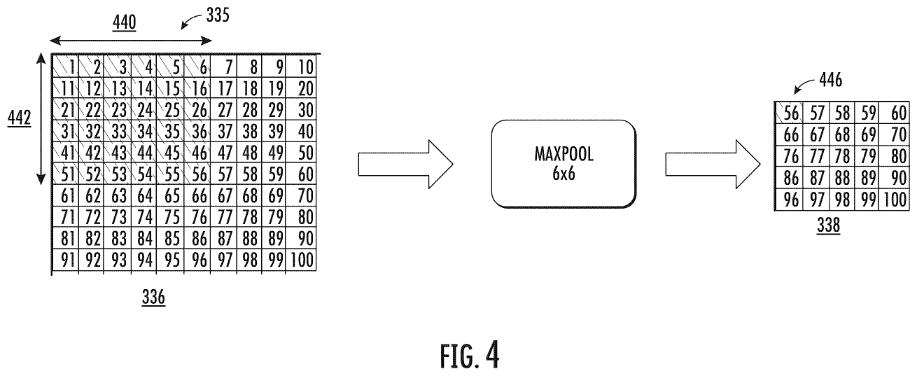

Referring now to FIG. 4, an example max pooling operation based on a 6×6 target max pooling filter 335 is provided. As depicted in FIG. 4, an example 10×10 input data map 336 comprising a two-dimensional array of example values is provided. An example 6×6 target max pooling filter 335 is depicted overlaying the values considered in the first iteration of the max pooling operation. As shown, the target max pooling filter 335 comprises a target max pooling filter width 440 of six and a target max pooling filter height 442 of six. Thus, during the first iteration, all values within the target max pooling filter 335 are considered and the max value, fifty-six, is written to the target output data map 338 at location 446 (0,0).

The depicted target output data map 338, shows the results of executing the 6×6 max pooling operation utilizing a max pooling stride parameter of 1 and no padding on the input data map 336.

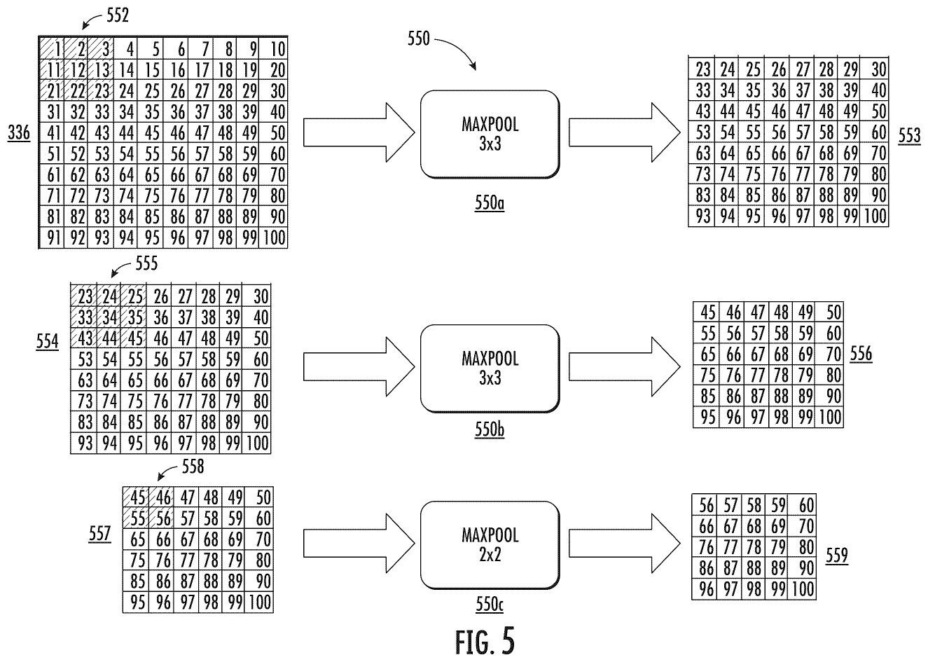

Referring now to FIG. 5, example execution of a max pooling operation using a cascaded max pooling filter 550 comprising a plurality of max pooling sub-filter operations 550a-550c performed in sequence, is provided. In the example of FIG. 5, the hardware acceleration device for which the cascaded max pooling filter 550 is designed has a hardware accelerated max pooling filter max height of three and a hardware accelerated max pooling filter max width of three. As depicted in FIG. 5, the example cascaded max pooling filter 550 replicates the execution of a 6×6 target max pooling filter (e.g., target max pooling filter 335 as depicted in FIG. 4). The cascaded max pooling filter 550 includes three max pooling sub-filters (e.g., max pooling sub-filters 552, 555, 558). Each max pooling sub-filter 552, 555, 558 receives an input data map (e.g., input data map 336, intermediate input data map 554, 557) and generates an output data map (e.g., intermediate output data map 553, 556, output data map 559). As depicted in FIG. 5, given an equivalent input data map 336, the cascaded max pooling filter 550 generates an equivalent output data map 559 to the target output data map 338 generated by the 6×6 target max pooling filter shown in FIG. 4.

As depicted in FIG. 5, a first max pooling sub-filter 552 comprising a width (e.g., max pooling sub-filter width) of three and a height (e.g., max pooling sub-filter height) of three. The first max pooling sub-filter 552 is applied during a max pooling sub-filter operation 550a executed on the input data map 336. The max pooling sub-filter operation 550a is further defined by a max pooling stride parameter of one and a max pooling padding parameter of zero (indicating no padding). By performing the max pooling sub-filter operation 550a according to the specified parameters, an intermediate output data map 553 is generated having a width of eight and a height of eight.

As further depicted in FIG. 5, a second max pooling sub-filter operation 550b is performed on the intermediate output data map 553 generated by the first max pooling sub-filter operation 550a (reproduced as intermediate input data map 554). The second max pooling sub-filter operation 550b utilizes a max pooling sub-filter 555 comprising a width of three and a height of three. The second max pooling sub-filter 555 is applied during a max pooling sub-filter operation 550b executed on the intermediate input data map 554. The max pooling sub-filter operation 550b is further defined by a max pooling stride parameter of one and a max pooling padding parameter of zero. By performing the max pooling sub-filter operation 550b according to the specified parameters, an intermediate output data map 556 is generated having a width of six and a height of six.

As further depicted in FIG. 5, a third max pooling sub-filter operation 550c is performed on the intermediate output data map 556 generated by the second max pooling sub-filter operation 550b (reproduced as intermediate input data map 557). The third max pooling sub-filter operation 550c utilizes a max pooling sub-filter 558 comprising a width of two and a height of two. The third max pooling sub-filter 558 is applied during a max pooling sub-filter operation 550c executed on the intermediate input data map 557. The max pooling sub-filter operation 550c is further defined by a max pooling stride parameter of one and a max pooling padding parameter of zero. By performing the max pooling sub-filter operation 550c according to the specified parameters, an output data map 559 is generated having a width of five and a height of five. Since the third max pooling sub-filter operation 550c is the last sub-filter in the cascaded max pooling filter 550, the resulting output data map (e.g., output data map 559) is equivalent to the target output data map 338 as generated by the 6×6 max pooling filter 335 depicted in FIG. 4.

As depicted in FIG. 5, a plurality of max pooling sub-filters 552, 555, 558 may be applied in a sequence of max pooling operations 550a, 550b, 550c comprising the cascaded max pooling filter 550, to generate an output data map 559 equivalent to the target output data map 338 generated by the target max pooling filter 335. In an instance in which the max and width of the plurality of max pooling sub-filters 552, 555, 558 are less than the corresponding dimensions of a hardware accelerated max pooling filter corresponding to the max dimensions of a hardware accelerated max filter configured to operate on a hardware acceleration device, the max pooling node may achieve higher performance. FIG. 6-FIG. 7 further describe example processes for determining a cascaded max pooling filter 550 for a given hardware acceleration device optimized for max pooling operations up to a hardware accelerated max pooling filter max width and a hardware accelerated max pooling filter max height.

Referring now to FIG. 6, an example process 660 for determining a cascaded max pooling filter (e.g., cascaded max pooling filter 550) for a hardware acceleration device (e.g., hardware acceleration device 332) is provided. In some embodiments, the process 660 may be executed by a controller (e.g., controller 334) connected to the hardware acceleration device on a max pooling node (e.g., max pooling node 330). At block 662, the controller receives a hardware accelerated max pooling filter max width and a hardware accelerated max pooling filter max height corresponding to a hardware acceleration device configured to perform optimized max pooling operations up to the hardware accelerated max pooling filter max width and the hardware accelerated max pooling filter max height on a two-dimensional input data map (e.g., input data map 220, input data map 336). As described herein, the controller may be associated with a hardware acceleration device configured to perform optimized max pooling operations for max pooling filters up to a given size. For example, a hardware acceleration device may be configured to optimize execution instructions for a max pooling filter up to a hardware accelerated max pooling filter max width and a hardware accelerated max pooling filter max height. Any max pooling filter exceeding either dimension may be executed by the host processor, significantly slowing the performance of the max pooling operation.

At block 662, the controller may receive max pooling hyperparameters including at least a max pooling padding parameter and a max pooling stride parameter. The max pooling padding parameter specifying an amount of padding to apply to each dimension of the input data map. The max pooling stride parameter specifying the movement of a max pooling filter (or max pooling sub-filter) between each iteration of the max pooling operation. The max pooling stride parameter may be managed in the max pooling sub-filter operation at which all the features of the target max pooling filter are first covered.

At block 664, the controller receives a target max pooling filter comprising a target max pooling filter height and a target max pooling filter width, wherein the target max pooling filter height is greater than the hardware accelerated max pooling filter max height or the target max pooling filter width is greater than the hardware accelerated max pooling filter max width. The height and width of a target max pooling filter may be adjusted based on the application comprising the max pooling node. In some embodiments, the type of input data, the operations performed in the hidden layers, the desired reduction in spatial dimensions, and other factors may be considered in determining the target max pooling filter width and height.

In an instance in which one or more dimensions of the target max pooling filter exceeds the corresponding limits of the associated hardware acceleration device, a cascaded max pooling filter may be generated to increase the performance of the max pooling node.

At block 664, the controller determines a cascaded max pooling filter (e.g., cascaded max pooling filter 337) comprising one or more max pooling sub-filters operations (e.g., max pooling sub-filter operations 550a-550c) executing a max pooling sub-filter (e.g., max pooling sub-filter 552, 555, 558), each of the one or more max pooling sub-filters comprising: a max pooling sub-filter width equal to or smaller than the hardware accelerated max pooling filter max width; and a max pooling sub-filter height equal to or smaller than the hardware accelerated max pooling filter max height; wherein sequentially applying each of the one or more max pooling sub-filters yields a two-dimensional output data map equivalent to a target output data map that would result from performing a max pooling operation using the target max pooling filter. As described herein, the controller determines a sequence of max pooling sub-filters to be executed sequentially, such that the output data map of the first max pooling sub-filter operation is provided as the input data map to the second max pooling sub-filter operation and so on. The resulting output data map of the cascaded max pooling filter is equivalent to the target output data map that would be generated in an instance in which a max pooling operation is executed on the input data map utilizing the target max pooling filter. However, the cascaded max pooling filter utilizes max pooling sub-filters having dimensions smaller than the max filter dimensions supported by the hardware acceleration device.

One or more of blocks 665-668 may be performed by the controller in determining the cascaded max pooling filter.

At block 665, the controller may determine a set of candidate max pooling sub-filter widths comprising each filter width supported by the hardware acceleration device having a valid output filter width. The hardware acceleration device is configured to support any max pooling filter width up to a hardware accelerated max pooling filter max width. For example, a hardware acceleration device may be configured to perform optimized max pooling operations on max pooling filters having a width up to three. Thus, the supported filter widths are the set of filter widths less than or equal to three (e.g., 1, 2, 3). The controller may determine the resulting output filter width for each of the filter widths supported by the hardware acceleration device.

In one embodiment, the output filter width may be determined based on Equation (1):

$${OF}_{width} = {IF}_{width} - {F}_{width} + 1 \qquad ( 1 )$$

where OF_{width} is the width of the output filter, IF_{width} is the width of the input max pooling filter, and F_{width} is the filter width supported by the hardware acceleration device.

An input max pooling filter represents the size of the target max pooling filter prior to the execution of the max pooling sub-filter operation utilizing a max pooling sub-filter. In the first iteration of a cascaded max pooling filter, the input max pooling filter is the target max pooling filter. The output filter represents the size of the input max pooling filter after a max pooling sub-filter operation based on a max pooling sub-filter has been executed. The output filter size becomes the input max pooling filter for the next iteration in a cascaded max pooling filter. For example, in an instance in which the input max pooling filter width is 6 and the filter width is 3, the output filter width is determined by Equation (1):

$${OF}_{width} = 6 - 3 + 1 = 4$$

Thus, the output filter width is 4.

The output filter width is determined for each filter width supported by the accelerated hardware device. A valid output filter width is any output filter width greater than zero. The controller is configured to select the maximum filter width supported by the accelerated hardware device resulting in a valid output filter width.

At block 666, the controller may determine a set of candidate max pooling sub-filter heights comprising each filter height supported by the hardware acceleration device having a valid output filter height. The hardware acceleration device is configured to support any max pooling filter height up to a hardware accelerated max pooling filter max height. For example, a hardware acceleration device may be configured to perform optimized max pooling operations on max pooling filters having a height up to three. Thus, the supported filter heights are the set of filter heights less than or equal to three (e.g., 1, 2, 3). The controller may determine the resulting output filter height for each of the filter heights supported by the hardware acceleration device.

In one embodiment, the output filter height may be determined based on Equation (2):

$${OF}_{height} = {IF}_{height} - {F}_{height} + 1 \qquad ( 2 )$$

where OF_{height} is the height of the output filter, IF_{height} is the height of the input max pooling filter, and F_{height} is the filter height supported by the hardware acceleration device.

An input max pooling filter represents the size of the target max pooling filter prior to the execution of the max pooling sub-filter operation utilizing a max pooling sub-filter. In the first iteration of a cascaded max pooling filter, the input max pooling filter is the target max pooling filter. The output filter represents the size of the input max pooling filter after a max pooling sub-filter operation based on a max pooling sub-filter has been executed. The output filter size becomes the input max pooling filter for the next iteration in a cascaded max pooling filter. For example, in an instance in which the input max pooling filter height is 6, the filter height is 3, the padding is 0, and the stride is 1, the output filter height is determined by Equation (2):

$${OF}_{height} = 6 - 3 + 1 = 4$$

Thus, the output filter height is 4.

The output filter height is determined for each filter height supported by the accelerated hardware device. A valid output filter height is any output filter height greater than zero. The controller is configured to select the maximum filter height supported by the accelerated hardware device resulting in a valid output filter height.

At block 667, the controller selects a max pooling sub-filter comprising a max pooling sub-filter width based on a maximum filter width in the set of candidate max pooling sub-filter widths, and a max pooling sub-filter height based on a maximum filter height in the set of candidate max pooling sub-filter heights. The max pooling sub-filter is configured based on the maximum filter width supported by the accelerated hardware device resulting in a valid output filter width and the maximum filter height supported by the accelerated hardware device resulting in a valid output filter height. Thus, in an instance in which the maximum filter width supported by the accelerated hardware device resulting in a valid output filter width is three, and the maximum filter height supported by the accelerated hardware device resulting in a valid output filter height is one, a 3×1 max pooling filter is designated as the next max pooling sub-filter in the cascaded max pooling filter.

At block 668, the controller configures the hardware acceleration device to execute the cascaded max pooling filter on the two-dimensional input data map. Once a cascaded max pooling filter is determined to replicate a target max pooling filter, the hardware acceleration device may be configured to sequentially execute the plurality of max pooling sub-filters on each received input data map. The plurality of max pooling sub-filters comprising the cascaded max pooling filter each comprise dimensions within the supported hardware accelerated max pooling dimensions. Configuring the hardware acceleration device to execute the cascaded max pooling filter in place of the target max pooling filter may result in significant performance gains on the max pooling node.

In some embodiments, the hardware acceleration device may comprise a plurality of hardware acceleration devices wherein each of the plurality of hardware acceleration devices comprises one or more max pooling sub-filter operations. In such an embodiment, the controller may configure a sequence of hardware acceleration devices to perform the cascaded max pooling filter.

In some embodiments, the controller may comprise a compiler. In such an embodiment, the compiler may configure the hardware accelerated device to execute the cascaded max pooling filter. In some embodiments, the hardware accelerated device may be dynamically reconfigured (e.g., recompiled), for example, during operation. Thus, the max pooling node may be reconfigured dynamically to update the cascaded max pooling filter based on the application.

Referring now to FIG. 7, an example flow chart depicting an example process 770 for determining a cascaded max pooling filter for a hardware acceleration device on a max pooling node associated with a controller (e.g., max pooling node 330 depicted in FIG. 3).

At step 771, the controller receives hardware constraints related to the hardware acceleration device. Hardware constraints may include maximum max pooling filter dimensions for which the hardware acceleration device is configured to perform optimized max pooling operations. For example, the hardware constraints may include a hardware accelerated max pooling filter max width indicating the maximum width of a max pooling filter for which the hardware acceleration device is configured to perform max pooling operations. The hardware constraints may further include a hardware accelerated max pooling filter max height indicating the maximum height of a max pooling filter for which the hardware acceleration device is configured to perform max pooling operations.

At step 772, the controller receives target max pooling parameters. The target max pooling parameters indicate the parameters/hyperparameters for a desired max pooling operation to be performed on one or more two-dimensional input data maps. The target max pooling parameters may include the dimensions of a target max pooling filter, for example, a target max pooling filter width and a target max pooling filter height. The target max pooling parameters may further include max pooling hyperparameters including a max pooling padding parameter and a max pooling stride parameter. In addition, the target max pooling parameters may include the size of the input data map. For example, in an instance in which a two-dimensional input data map is input, a width and height of the two-dimensional input data map may be provided. For purposes of description, the values contained in a two-dimension input data map may be described using x and y coordinates, although the two-dimensional input data map may be accessed via a sequential or non-sequential memory address.

At step 773, a pad test is performed to determine if padding needs to be managed. The pad test determines if the first max pooling sub-filter of the cascaded max pooling filter is being determined, and if there is padding indicated in the max pooling parameter. If the first max pooling sub-filter of the cascaded max pooling filter is being determined and there is padding indicated in the max pooling parameter, the process 770 continues at step 774 where the padding is managed. Otherwise, if there is no padding or the first max pooling sub-filter has already been determined, the process 770 continues at step 775.

At step 774, any padding indicated by a max pooling padding parameter is managed. The effect of padding indicated by a max pooling padding parameter may only be managed during the determination of the first max pooling sub-filter. The starting position of the first max pooling sub-filter will always be the coordinate (0, 0), however, if the max pooling padding parameter is greater than 0, the first max pooling sub-filter operation will consider the padding values at each of the edges of the input data map.

At step 775, a max pooling sub-filter is selected. The controller determines the max pooling sub-filter width and max pooling sub-filter height based on the maximum width and height resulting in a valid output filter given a particular input max pooling filter. An input max pooling filter represents the size of the target max pooling filter prior to the execution of the particular max pooling sub-filter operation. In the first iteration of a cascaded max pooling filter, the input max pooling filter is the target max pooling filter. The output filter represents the size of the input max pooling filter after a particular max pooling sub-filter operation has been executed.

In some embodiments, the max pooling sub-filter width and the max pooling sub-filter height may be determined independently. To determine the max pooling sub-filter width, the controller may iterate through each of the max pooling filter widths optimized by the hardware acceleration device. For example, in an instance in which the hardware accelerated max pooling filter max width is 4, the supported max pooling filter widths are 1, 2, 3, and 4. The controller may determine the resulting output filter width for each of the max pooling filter widths supported by the hardware acceleration device.

In one embodiment, the output filter width may be determined based on Equation (3):

$${OF}_{width} = {IF}_{width} - {F}_{width} + 1 \qquad ( 3 )$$

where OF_{width} is the width of the output filter, IF_{width} is the width of the input max pooling filter, and F_{width} is the filter width supported by the hardware acceleration device. The controller may then select the maximum max pooling filter width supported by the hardware acceleration device resulting in a valid output filter width (e.g., greater than 0) as the max pooling sub-filter width.

To determine the max pooling sub-filter height, the controller may iterate through each of the max pooling filter heights optimized by the hardware acceleration device. For example, in an instance in which the hardware accelerated max pooling filter max height is 4, the supported max pooling filter heights are 1, 2, 3, and 4. The controller may determine the resulting output filter height for each of the max pooling filter heights supported by the hardware acceleration device.

In one embodiment, the output filter height may be determined based on Equation (4):

$${OF}_{height} = {IF}_{height} - {F}_{height} + 1 \qquad ( 4 )$$

where OF_{height} is the height of the output filter, IF_{height} is the height of the input max pooling filter, and F_{height} is the filter height supported by the hardware acceleration device. The controller may then select the maximum max pooling filter height supported by the hardware acceleration device resulting in a valid output filter height (e.g., greater than 0) as the max pooling sub-filter height.

At step 776, the controller may compute the remaining features of the input max pooling filter that are not included in the max pooling sub-filter determined in step 775. The remaining features in the x direction (input max pooling filter width) may be determined using Equation (3) above, where IF_{width} is the width of the input max pooling filter at the selected max pooling sub-filter operation, and F_{width} is the width of the selected max pooling sub-filter. For example, if a max pooling sub-filter having a width of 3 is selected at step 775 and the input max pooling filter width is 6, there are (6−3+1=4)4 remaining features in the x direction.

Similarly, the remaining features in the y direction (input max pooling filter height) may be determined by Equation (4) above, where IF_{height} is the height of the input max pooling filter at the selected max pooling sub-filter operation, and F_{height} is the height of the selected max pooling sub-filter. For example, if a max pooling sub-filter having a height of 3 is selected at step 775 and the input max pooling filter height is 6, there are (6−3+1=4)4 remaining features in the y direction.

At step 777, the controller executes a stride test to determine whether the stride needs to be accounted for. The controller executing the stride test first determines if all of the features of the input max pooling filter are covered by the selected max pooling sub-filter in each direction. In other words, are the remaining features in the x direction or the remaining features in the y direction equal to 1. Next, the controller executing the stride test determines if the stride is greater than 1. In an instance in which the remaining features in the x direction or the remaining features in the y direction are equal to 1 and the stride is greater than 1, execution continues at step 778 where the stride is managed in the dimensions or dimensions in which the remaining features are covered. In some examples, the stride may be managed in different max pooling sub-filter operations, for example, if the remaining features are covered at different max pooling sub-filter operations in the different dimensions. Otherwise, execution continues at step 779.

At step 778, the controller manages any max pooling stride parameter greater than 1. In an instance in which the max pooling stride parameter is greater than 1, the cascaded max pooling filter may only manage the stride in the first max pooling sub-filter operation in which all the features of the input max pooling filter are covered in a particular dimension. The max pooling stride parameter is managed by applying the max pooling stride parameter to the max pooling sub-filter operation utilizing the selected max pooling sub-filter first covering all of the features of the input max pooling map in the particular dimension. By applying the stride parameter in the covered dimension at this stage of the cascaded max pooling filter, the resulting output data map replicates the output data map of the target max pooling filter comprising a max pooling stride parameter.

At step 779, the selected max pooling sub-filter is added to the cascaded max pooling filter. The selected max pooling sub-filter is further associated with any stride determined at step 778.

At step 780, the controller executes a complete test to determine whether the cascaded max pooling filter is complete. The complete test determines if all of the features of the input max pooling filter are covered by the selected max pooling sub-filter in each dimension. In other words, are the remaining features in the x direction and the remaining features in the y direction are both equal to 1. In an instance in which the remaining features in both directions are equal to 1, execution continues at step 781. In an instance in which there are remaining features in the x direction or the y direction, execution continues at step 773.

At step 781, execution of the process 770 is complete. The sequence of selected max pooling sub-filters comprises the cascaded max pooling filter. Execution of the selected max pooling sub-filters in sequence replicates execution of the target max pooling filter. At step 781, the controller may configure the hardware acceleration device to execute the cascaded max pooling filter.

Referring now to FIG. 8, an example cascaded max pooling filter 550 operation depicting input max pooling filters 880, 882, 884 and output filters 881, 883, 885 is provided.

As depicted in FIG. 8, the example cascaded max pooling filter 550 is selected to replicate a 6×6 target max pooling filter with no padding and a stride of 1, such as the operation depicted in FIG. 4. The cascaded max pooling filter 550 includes a sequence of three max pooling sub-filters 552, 555, 558 executed at max pooling sub-filter operations 550a, 550b, 550c respectively. The first max pooling sub-filter operation 550a is configured to receive the input data map 336 and execute a max pooling operation based on the 3×3 max pooling sub-filter 552 to generate an intermediate output data map 553. The second max pooling sub-filter operation 550b is configured to receive the intermediate input data map 554 (equivalent to the intermediate output data map 553) and execute a max pooling operation based on the 3×3 max pooling sub-filter 555 to generate an intermediate output data map 556. The third max pooling sub-filter operation 550c is configured to receive the intermediate input data map 557 (equivalent to the intermediate output data map 556) and execute a max pooling operation based on the 2×2 max pooling sub-filter 558 to generate output data map 559.

As further depicted in FIG. 8, the input max pooling filters 880, 882, 884 and the output filters 881, 883, 885 at each max pooling sub-filter operation 550a, 550b, 550c are depicted. The first input max pooling filter 880 is equal in size (6×6) to the target max pooling filter. The output filter 881 represents the scope of the input max pooling filter 880 after the max pooling sub-filter operation 550a is executed. As depicted in FIG. 8, the output filter 881 is 4×4 after being reduced by the max pooling sub-filter operation 550a. The output filter 881 size becomes the input max pooling filter 882 size at the next stage of the cascaded max pooling filter 550 operation.

As further depicted in FIG. 8, the second input max pooling filter 882 is equal in size (4×4) to the output filter 881 of the previous max pooling sub-filter operation 550a. The output filter 883 represents the scope of the input max pooling filter 882 after the max pooling sub-filter operation 550b is executed. As depicted in FIG. 8, the output filter 883 is 2×2 after being reduced by the max pooling sub-filter operation 550b. The output filter 883 size becomes the input max pooling filter 884 size at the next stage of the cascaded max pooling filter 550 operation.

As further depicted in FIG. 8, the third input max pooling filter 884 is equal in size (2×2) to the output filter 883 of the previous max pooling sub-filter operation 550b. The output filter 885 represents the scope of the input max pooling filter 884 after the max pooling sub-filter operation 550c is executed. As depicted in FIG. 8, the output filter 885 is 1×1 after being reduced by the max pooling sub-filter operation 550c. As further depicted, the max pooling sub-filters 558 completely covers the input max pooling filter 884 representing the scope of the target max pooling filter at the max pooling sub-filter operation 550c. Since there are no remaining features, the max pooling sub-filter operation 550c signals the end of the cascaded max pooling filter 550. In an instance in which a max pooling stride parameter greater than 1 is provided, the max pooling stride parameter would be applied at the max polling sub-filter operation 550c. The resulting output data map 559 is equivalent to the output data map if the target max pooling filter (6×6) were applied.

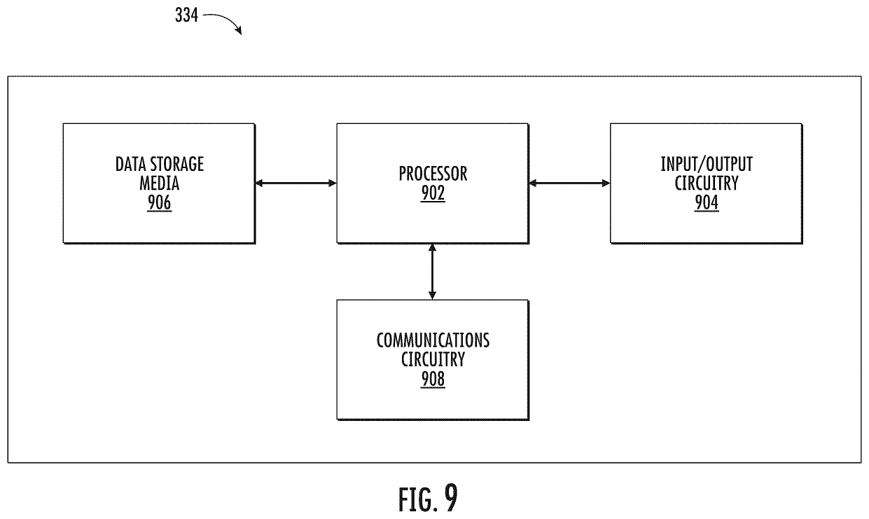

Referring now to FIG. 9, FIG. 9 illustrates an example controller 334 in accordance with at least some example embodiments of the present disclosure. The controller 334 includes processor 902, input/output circuitry 904, data storage media 906, and communications circuitry 908. In some embodiments, the controller 334 is configured, using one or more of the sets of circuitry 902, 904, 906, and/or 908, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the controller 334 provide or supplement the functionality of other particular sets of circuitry. For example, the processor 902 in some embodiments provides processing functionality to any of the sets of circuitry, the data storage media 906 provides storage functionality to any of the sets of circuitry, the communications circuitry 908 provides network interface functionality to any of the sets of circuitry, and/or the like.

In some embodiments, the processor 902 (and/or co-processor or any other processing circuitry assisting or otherwise associated with the processor) is/are in communication with the data storage media 906 via a bus for passing information among components of the controller 334. In some embodiments, for example, the data storage media 906 is non-transitory and may include, for example, one or more volatile and/or non-volatile memories. In other words, for example, the data storage media 906 in some embodiments includes or embodies an electronic storage device (e.g., a computer readable storage medium). In some embodiments, the data storage media 906 is configured to store information, data, content, applications, instructions, or the like, for enabling the controller 334 to carry out various functions in accordance with example embodiments of the present disclosure.

The processor 902 may be embodied in a number of different ways. For example, in some example embodiments, the processor 902 includes one or more processing devices configured to perform independently. Additionally, or alternatively, in some embodiments, the processor 902 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 334, and/or one or more remote or “cloud” processor(s) external to the controller 334.

In an example embodiment, the processor 902 is configured to execute instructions stored in the data storage media 906 or otherwise accessible to the processor. Alternatively, or additionally, the processor 902 in some embodiments is configured to execute hard-coded functionality. As such, whether configured by hardware or software methods, or by a combination thereof, the processor 902 represents an entity (e.g., physically embodied in circuitry) capable of performing operations according to an embodiment of the present disclosure while configured accordingly. Alternatively, or additionally, as another example in some example embodiments, when the processor 902 is embodied as an executor of software instructions, the instructions specifically configure the processor 902 to perform the algorithms embodied in the specific operations described herein when such instructions are executed.

In some embodiments, the controller 334 includes input/output circuitry 904 that provides output to the user and, in some embodiments, to receive an indication of a user input. In some embodiments, the input/output circuitry 904 is in communication with the processor 902 to provide such functionality. The input/output circuitry 904 may comprise one or more user interface(s) (e.g., user interface) and in some embodiments includes a display that comprises the interface(s) rendered as a web user interface, an application user interface, a user device, a backend system, or the like. The processor 902 and/or input/output circuitry 904 comprising the processor may be configured to control one or more functions of one or more user interface elements through computer program instructions (e.g., software and/or firmware) stored on a memory accessible to the processor (e.g., data storage media 906, and/or the like). In some embodiments, the input/output circuitry 904 includes or utilizes a user-facing application to provide input/output functionality to a client device and/or other display associated with a user.

In some embodiments, the controller 334 includes communications circuitry 908. The communications circuitry 908 includes any means such as a device or circuitry embodied in either hardware or a combination of hardware and software that is configured to receive and/or transmit data from/to a network and/or any other device, circuitry, or module in communication with the controller 334. In this regard, the communications circuitry 908 includes, for example in some embodiments, a network interface for enabling communications with a wired or wireless communications network. Additionally, or alternatively in some embodiments, the communications circuitry 908 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 908 includes circuitry for interacting with the antenna(s) and/or other hardware or software to cause transmission of signals via the antenna(s) or to handle receipt of signals received via the antenna(s). In some embodiments, the communications circuitry 908 enables transmission to and/or receipt of data from a client device in communication with the controller 334.

Additionally, or alternatively, in some embodiments, one or more of the sets of circuitry 902-914 are combinable. Additionally, or alternatively, in some embodiments, one or more of the sets of circuitry perform some or all of the functionality described associated with another component. For example, in some embodiments, one or more sets of circuitry 902-908 are combined into a single module embodied in hardware, software, firmware, and/or a combination thereof. Similarly, in some embodiments, one or more of the sets of circuitry is/are combined such that the processor 902 performs one or more of the operations described above with respect to each of these circuitry individually.

While this detailed description has set forth some embodiments of the present invention, the appended claims cover other embodiments of the present invention which differ from the described embodiments according to various modifications and improvements. For example, one skilled in the art may recognize that such principles may be applied to any processing device configured to optimize performance of a max pooling operation. For example, feature recognition in an image processing application, object localization in an image, a compute node in a convolutional neural network, natural language processing applications, feature extraction, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An apparatus, comprising:
a hardware acceleration device configured to perform optimized max pooling operations up to a hardware accelerated max pooling filter max width and a hardware accelerated max pooling filter max height on a two-dimensional input data map; and
a controller electrically connected to the hardware acceleration device and configured to:
receive a target max pooling filter comprising a target max pooling filter height and a target max pooling filter width, wherein the target max pooling filter height is greater than the hardware accelerated max pooling filter max height, or the target max pooling filter width is greater than the hardware accelerated max pooling filter max width; and
determine a cascaded max pooling filter comprising one or more max pooling sub-filters, each of the one or more max pooling sub-filters comprising a max pooling sub-filter width equal to or smaller than the hardware accelerated max pooling filter max width and a max pooling sub-filter height equal to or smaller than the hardware accelerated max pooling filter max height;
wherein sequentially applying each of the one or more max pooling sub-filters yields a two-dimensional output data map equivalent to a target output data map that would result from performing a max pooling operation using the target max pooling filter.

2. The apparatus of claim 1, wherein the controller is configured to receive max pooling hyperparameters including at least a max pooling padding parameter or a max pooling stride parameter.

3. The apparatus of claim 1, wherein the controller comprises a compiler.

4. The apparatus of claim 3, wherein the compiler configures the hardware acceleration device to execute the cascaded max pooling filter on the two-dimensional input data map.

5. The apparatus of claim 3, wherein the compiler reconfigures the hardware acceleration device during operation to execute a second cascaded max pooling filter based on a second target max pooling filter.

6. The apparatus of claim 1, wherein the hardware acceleration device represents a computational node in a convolutional neural network.

7. A computer-implemented method, comprising:
receiving a hardware accelerated max pooling filter max width and a hardware accelerated max pooling filter max height corresponding to a hardware acceleration device configured to perform optimized max pooling operations up to the hardware accelerated max pooling filter max width and the hardware accelerated max pooling filter max height on a two-dimensional input data map;
receiving a target max pooling filter comprising a target max pooling filter height and a target max pooling filter width,
wherein the target max pooling filter height is greater than the hardware accelerated max pooling filter max height, or the target max pooling filter width is greater than the hardware accelerated max pooling filter max width; and
determining a cascaded max pooling filter comprising one or more max pooling sub-filters, each of the one or more max pooling sub-filters comprising:
a max pooling sub-filter width equal to or smaller than the hardware accelerated max pooling filter max width; and
a max pooling sub-filter height equal to or smaller than the hardware accelerated max pooling filter max height;
wherein sequentially applying each of the one or more max pooling sub-filters yields a two-dimensional output data map equivalent to a target output data map that would result from performing a max pooling operation using the target max pooling filter.

8. The computer-implemented method of claim 7, wherein determining the cascaded max pooling filter further comprises, for each max pooling sub-filter:
determining a set of candidate max pooling sub-filter widths comprising each filter width supported by the hardware acceleration device having a valid output filter width;
determining a set of candidate max pooling sub-filter heights comprising each filter height supported by the hardware acceleration device having a valid output filter height; and
selecting a max pooling sub-filter comprising a max pooling sub-filter width based on a maximum filter width in the set of candidate max pooling sub-filter widths, and a max pooling sub-filter height based on a maximum filter height in the set of candidate max pooling sub-filter heights.

9. The computer-implemented method of claim 8, wherein for each filter width supported by the hardware acceleration device, the output filter width is determined based at least in part on an input filter width and the filter width supported by the hardware acceleration device; and
wherein for each filter height supported by the hardware acceleration device, the output filter height is determined based at least in part on an input filter height and the filter height supported by the hardware acceleration device.

10. The computer-implemented method of claim 9, wherein dimensions of a first input filter are based on the target max pooling filter, and dimensions of a subsequent input filter are based on the output filter width and the output filter height from a previous iteration of the cascaded max pooling filter.

11. The computer-implemented method of claim 8, wherein the one or more max pooling sub-filters are selected until a selected max pooling sub-filter width is greater than or equal to the output filter width; and a selected max pooling sub-filter height is greater than or equal to the output filter height.

12. The computer-implemented method of claim 8, further comprising:
receiving max pooling hyperparameters including at least a max pooling padding parameter or a max pooling stride parameter.

13. The computer-implemented method of claim 12, wherein in an instance in which the max pooling padding parameter is greater than one, the output filter width and the output filter height are determined based at least in part on the max pooling padding parameter.

14. The computer-implemented method of claim 12, wherein in an instance in which the max pooling stride parameter is greater than one, the output filter width and the output filter height are determined based at least in part on the max pooling stride parameter.

15. The computer-implemented method of claim 7, further comprising:
configuring the hardware acceleration device to execute the cascaded max pooling filter on the two-dimensional input data map.

16. A computer program product having computer-readable program code portions stored therein, the computer-readable program code portions comprising an executable portion configured to:
receive a hardware accelerated max pooling filter max width and a hardware accelerated max pooling filter max height corresponding to a hardware acceleration device configured to perform optimized max pooling operations up to the hardware accelerated max pooling filter max width and the hardware accelerated max pooling filter max height on a two-dimensional input data map;
receive a target max pooling filter comprising a target max pooling filter height and a target max pooling filter width,
wherein the target max pooling filter height is greater than the hardware accelerated max pooling filter max height, or the target max pooling filter width is greater than the hardware accelerated max pooling filter max width; and
determine a cascaded max pooling filter comprising one or more max pooling sub-filters, each of the one or more max pooling sub-filters comprising:
a max pooling sub-filter width equal to or smaller than the hardware accelerated max pooling filter max width; and
a max pooling sub-filter height equal to or smaller than the hardware accelerated max pooling filter max height;
wherein sequentially applying each of the one or more max pooling sub-filters yields a two-dimensional output data map equivalent to a target output data map that would result from performing a max pooling operation using the target max pooling filter.

17. The computer program product of claim 16, wherein the computer-readable program code portions comprising the executable portion are further configured to:
configure the hardware acceleration device to execute the cascaded max pooling filter on the two-dimensional input data map.

18. The computer program product of claim 16, wherein to determine the cascaded max pooling filter, the computer-readable program code portions comprising the executable portion are further configured to, for each max pooling sub-filter:
determine a set of candidate max pooling sub-filter widths comprising each filter width supported by the hardware acceleration device having a valid output filter width;
determine a set of candidate max pooling sub-filter heights comprising each filter height supported by the hardware acceleration device having a valid output filter height; and
select a max pooling sub-filter comprising a max pooling sub-filter width based on a maximum filter width in the set of candidate max pooling sub-filter widths, and a max pooling sub-filter height based on a maximum filter height in the set of candidate max pooling sub-filter heights.

19. The computer program product of claim 18, wherein for each filter width supported by the hardware acceleration device, the output filter width is determined based at least in part on an input filter width and the filter width supported by the hardware acceleration device; and
wherein for each filter height supported by the hardware acceleration device, the output filter height is determined based at least in part on an input filter height and the filter height supported by the hardware acceleration device.

20. The computer program product of claim 19, wherein subsequent output filter dimensions are determined based on the output filter from a previous iteration and the max pooling sub-filter.
